(19) United States
(12) Patent Application Publication
(10) Pub. No.: US 2025/0058840 A1
(43) Pub. Date: Feb. 20, 2025

(54) GUARD FOR LAND VEHICLE DRIVE

(71) Applicant: Ernie Freeman, Rocky River, OH (US)

(72) Inventor: Ernie Freeman, Rocky River, OH (US)

(21) Appl. No.: 18/449,030

(22) Filed: Aug. 14, 2023

(51) Int. Cl. B62D 55/088

(52) U.S. Cl. CPC B62D 55/088

(57) ABSTRACT

A machine having a drive assembly including a circular body fixed to a chassis of the vehicle, the drive including a rotating output member outward of the circular body and defining an axis of revolution, the drive assembly forming an annular radially constricted zone between the circular body and the output member being prone to accumulate debris that can enter the drive assembly, a diametrally split guard of two segments fixed around the circular body, such segments each being unitary and extending from the circular body to the output member so that together the segments enclose said zone and diminish accumulation of debris in said zone.

### BACKGROUND OF THE INVENTION

The invention relates to land vehicles and, in particular, to debris guards such as for excavator track drives.

### PRIOR ART

I have invented numerous guards for bulldozers and compactors. These are shown, for example, in U.S. Pat. No. 6,231,136, 6,293,631, 7,731,307, 7,946,661, RE 45,491 and 11,208,163. There has remained a need for a debris guard for track type excavators, particularly for those operating in landfills that typically include, as debris, wire cable and like strands that wind around the drive elements and ultimately destroy drive components. The stranded material may enter the drive interior by abrasion or other action and may destroy internal parts of the drive.

### DESCRIPTION OF THE INVENTION

The invention is embodied as a split sleeve such as for a track type excavator that extends over outboard parts of the drive. The disclosed embodiment not only avoids modification of an excavator but also avoids a need to disassemble the original drive for installation.

The guard split halves or segments extend continuously from the machine chassis or undercarriage to a sprocket hub associated with ground track in a rugged structure resistant to damage during operation.

### BRIEF DESCRIPTION OF THE DRAWINGS

FIG. 1 illustrates an excavating machine on which the present invention is employed;

FIG. 2 is an elevational view of the drive area protected by the inventive guard which is shown in cross-section; and

FIG. 3 is a perspective view of the inventive guard.

### DESCRIPTION OF THE PREFERRED EMBODIMENT

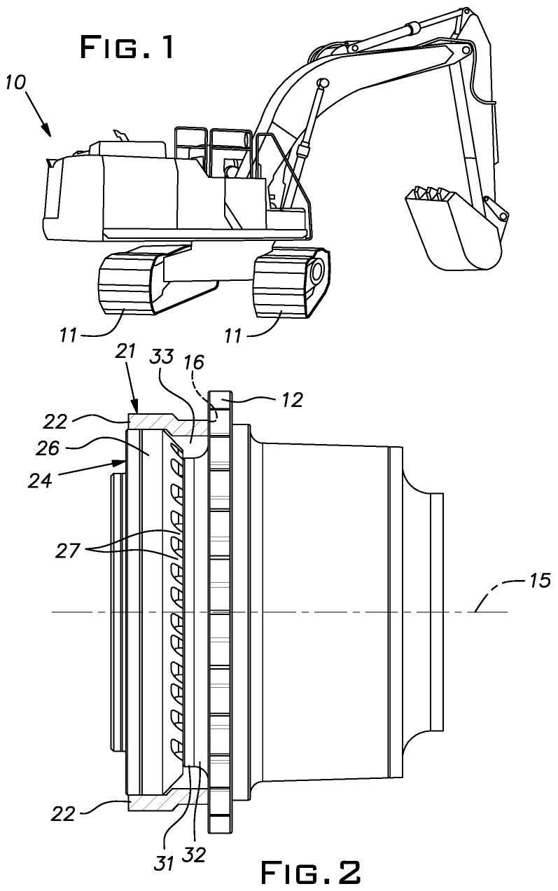

An excavating machine 10, mounted on ground engaging tracks 11 is illustrated in FIG. 1.

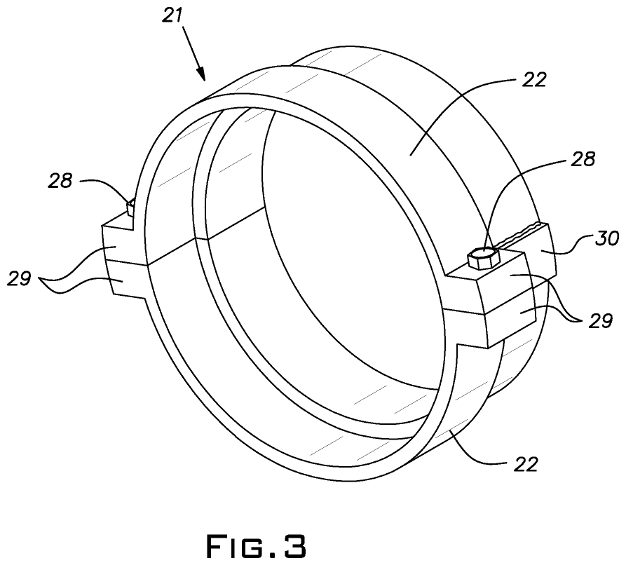

FIG. 2 shows drive components of the machine 10 including a sprocket 12 that engages and drives the track 11 in a known manner. While FIG. 2 illustrates the right side drive and guard, a like drive and guard is employed on the left side of the machine 10.

A hydraulic motor (not shown) is disposed on an axis of rotation 15 within the undercarriage (not shown) to the left of the drive components shown in FIG. 2. The motor rotates a sprocket hub or output member 16, to which the sprocket 12 is fired, about the axis 15.

Apart from a guard 21 of the invention discussed in greater detail below and shown in cross-section, all of the elements shown in FIG. 2 are original equipment supplied and installed by the manufacturer of the machine 10. A non-rotating circular body 24 is bolted to the undercarriage of the machine 10 with a cylindrical surface 26 projecting outwardly from the undercarriage.

The guard 21 comprises two half cylinders 22 proportioned to fit tightly around the surface 26. With reference to FIG. 3, the half cylinders 22 are held to each other with bolts 28 through flanges 29. With the major diameter portions of the guard half cylinders assembled around surface 26, tightening of the bolts 28 locks these guard elements onto the surface. The guard half cylinders 22 have a length and are stepped down in radius outboard of the body 24 to enable their ends to abut or very nearly abut (within 3/16 inch) the sprocket hub 16 while being radially inward of the path of the track chain. While not shown, the hub 16 and sprocket 12 may be integral and the guard 21 can be arranged to about or nearly abut the sprocket. At opposite sides of the guard halves 22 a small plate 30 can be welded to one of the halves to seal any gap where the halves are split. Each half cylinder 22 is one-piece, being a steel casting, forging, weldment, or fabrication.

An outboard face of the circular body 24 is formed with teeth 27. The circular body 24 does not rotate while parts, including a part 31 engaging a face of the body 24, and an adjacent part 32 of the drive components rotate. The body 24 and parts 31 and 32 form an annular pocket or valley 33 that is of reduced diameter from adjacent major diameters of these elements. It has been found that the pocket 33 accumulates debris, especially stranded debris with the result that such debris works its way into the interior of the drive elements and thereby destroys critical internal parts. The inventive cover or guard 21 reduces the risk of accumulating debris abrading or otherwise destroying critical drive parts.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A machine having a drive assembly including a circular body fixed to a chassis of the vehicle, the drive including a rotating output member outward of the circular body and defining an axis of revolution, the drive assembly forming an annular radially constricted zone between the circular body and the output member being prone to accumulate debris that can enter the drive assembly, a diametrally split guard of two segments fixed around the circular body, such segments each being unitary and extending from the circular body to the output member so 10 that together the segments enclose said zone and diminish accumulation of debris in said zone.

2. A machine as set forth in claim 1, wherein said guard extends axially to a plane at or adjacent a track sprocket.

3. A machine as set forth in claim 2, wherein the output member has the track sprocket outward of said output member.

4. A machine as set forth in claim 1, wherein said segments are smaller in radius at an outboard end than a radius at an inboard end.

5. A guard for an external drive of a ground vehicle, the guard adapted to be fixed to the exterior of the vehicle and having elements that extend, in one piece, from the vehicle to a sprocket and sprocket hub assembly, the guard when assembled on the machine enclosing a space through which the external drive extends.

6. A cylindrical guard for protecting a space between a track sprocket and an adjacent non-rotating original equipment part of a track type excavator machine supporting the sprocket, the guard being formed of two semi-circular halves, each half having a semi-circular shell adapted to mate with the other semi-circular shell and a factory installed radially outward cylindrical surface at one end of the shell, the length of each shell being proportioned to seal between a shell end opposite the cylindrical surface and a factory installed rotating drive part, each semi-cylindrical shell having a length such that when mounted on the cylindrical surface the end opposite the cylindrical surface forms a running or small gap seal with the factory installed drive part.

7. A cylindrical guard as set forth in claim 6, wherein the semi-circular shells have one radius at said cylindrical surface and a smaller radius at said opposite end.
